(19) United States
(12) Patent Application Publication
(10) Pub. No.: US 2013/0098880 A1
(43) Pub. Date: Apr. 25, 2013

(54) INJECTOR FOR PLASMA SPRAY TORCHES

(71) Applicants: Alexander Korolev, Burnaby (CA); Zbigniew Celler, North Vancouver (CA)

(72) Inventors: Alexander Korolev, Burnaby (CA); Zbigniew Celler, North Vancouver (CA)

(73) Assignee: NORTHWEST METTECH CORP., North Vancouver (CA)

(21) Appl. No.: 13/600,857

(22) Filed: Aug. 31, 2012

Related U.S. Application Data
(60) Provisional application No. 61/529,692, filed on Aug. 31, 2011.

(51) Int. Cl. B23K 10/00

(52) U.S. Cl. CPC B23K 10/00
USPC 219/121.5

(57) ABSTRACT

A liquid-in-gas injector tube in which the diameter of the inner liquid-bearing tube within the gas-transmitting tube is reduced adjacent the outlet end of the injector. Clogging may be further reduced by adding vanes to the outer surface of the inner liquid-bearing tube within the gas-transmitting tube to impart swirling or otherwise focus the flow of gas at the exit of the injector tube.

### CROSS REFERENCE TO RELATED APPLICATION

The present application claims the benefits, under 35 U.S.C. §119(e), of U.S. Provisional Application Ser. No. 61/529,692 filed Aug. 31, 2011 which is incorporated herein by this reference.

### TECHNICAL FIELD

The invention relates to the field of thermal spray coating and more particularly thermal spray coating using liquid feedstock.

### BACKGROUND

Currently in axial injection torches the liquid feedstock is injected axially in the center of a number of plasma channels. The size of the injector is limited to the dimensions between the plasma channels. Clogging at the injector is a problem in thermal spraying of liquid feedstocks to produce thermal spray coatings. The manner of injection of the slurry is critical in preventing clogging. Typically clogging can be caused at the injection point. Also it is desirable to reduce the pressure required in the liquid feedstock feed lines. Operating the feed lines at a lower pressure saves energy costs but also lower pressure results in a longer lifetime for the peristaltic pump tubing, which reduces maintenance costs. Thirdly, less volume of pressure dampener is required in the feedstock to provide the necessary smoothing of pressure pulses for the peristaltic pump. As a result less of the costly liquid is lost when residual pressure forces it out of the feed line when the pump is stopped. Fourthly, operating at a lower pressure opens up a greater variety of pumps which can be used or a pressurized tank.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope.

In various embodiments, one or more of the above-described problems have been reduced or eliminated, while other embodiments are directed to other improvements.

The present invention is aimed at minimizing clogging at the injector while reducing the pressure required in the injection lines. It does this by providing a liquid-in-gas injector tube in which the diameter of the inner liquid-bearing tube within the gas-transmitting tube is reduced adjacent the outlet end of the injector. Clogging may be further reduced by adding vanes to the outer surface of the inner liquid-bearing tube within the gas-transmitting tube to impart swirling or otherwise focus the flow of gas at the exit of the injector tube.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a schematic diagram illustrating a thermal spray system which uses the invention.

FIG. 2 is a perspective view of the injector tubes and convergence blank of a torch which uses the invention.

FIG. 3 is a front view of the convergence blank shown in FIG. 2.

FIG. 4 is a side elevation in vertical cross-section of the injector tubes and convergence blank shown in FIG. 2.

FIG. 5 is a side elevation partly in vertical cross-section of a first embodiment of an injector tube according to the invention.

FIG. 6 is a detail of section A shown in FIG. 5.

FIG. 7 is a side elevation partly in vertical cross-section of the inner tube for the injector tube shown in FIG. 5.

FIG. 8 is a detail of section B shown in FIG. 7.

FIG. 9 is a perspective view of the inner tube of a second embodiment of an injector tube according to the invention.

FIG. 10 is a side elevation partly in vertical cross-section of an injector tube according to the invention having the inner tube according to the embodiment shown in FIG. 9.

FIG. 11 is a detail of section C shown in FIG. 10.

FIG. 12 is an end of the injector tube shown in FIG. 10.

FIG. 13 is a detail of section D shown in FIG. 14.

FIG. 14 is a side elevation partly in vertical cross-section of an injector tube according to the invention having the inner tube according to the embodiment shown in FIG. 13.

FIG. 15 is an end of the injector tube shown in FIG. 13.

FIG. 16 is a detail of section A shown in FIG. 17.

FIG. 17 is a side elevation partly in vertical cross-section of an injector tube according to the invention having the inner tube according to the embodiment shown in FIG. 16.

FIG. 18 is an end of the injector tube shown in FIG. 17.

FIG. 19 is a table of test results showing pressure in the injection lines in the vertical axis against flow rate in ml/m. in the horizontal axis using the improved injector.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The invention is applied to thermal spray using liquid feedstocks. Where the following description refers to a liquid slurry comprising suspended nanopowders, it also includes a liquid precursor having dissolved solids such as salts. Such liquid precursors are handled in the same way in the invention as liquid slurries but when the precursor enters the plasma, some of the liquid evaporates and the dissolved solids react in the plasma to form the solid material which is sprayed from the torch, whereas with liquid slurries the liquid evaporates leaving the suspended solid particles.

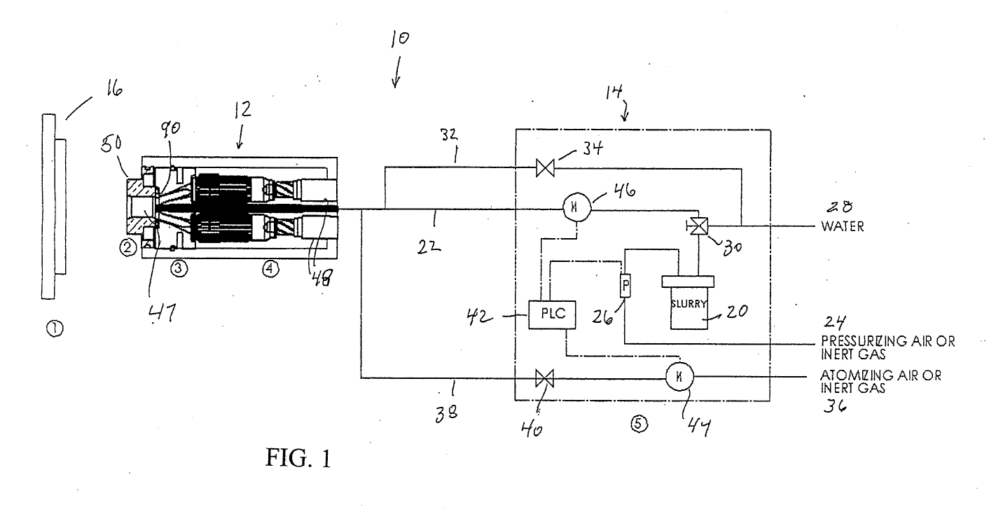

With reference to FIG. 1, a thermal spray system 10 as disclosed in the Applicant's international application, publication no. WO 2009/143626, comprises an axial injection torch 12 and a liquid feedstock delivery unit 14. The system directs a thermal spray at target substrate 16 to provide a coating on the surface of substrate 16. Slurry delivery unit 14 comprises a source of feedstock slurry or liquid precursor 20 which is delivered to torch 12 via conduit 22. The slurry or precursor is delivered by a source of pressurizing air or inert gas 24 which is regulated by pressure regulator 26. A source of water 28 may provide water to the slurry conduit 22 to flush or clean conduit 22 either through valve 30 or conduit 32 and valve 34 downstream of the valve 30. A source of atomizing air or inert gas is provided at 36 and provides the atomizing gas to the atomizer in torch 12 through conduit 38 and valve 40. A programmable logic controller 42 controls the process by monitoring flow meters 44, 46 and pressure regulator 26 and regulating the flow of slurry, and pressurizing and atomizing gas. A feedback control loop is thereby formed for controlling the liquid feedstock either with external pressure to the liquid reservoir or pump speed. Flow meter 44 is preferably a mass flow meter which meters the amount of atomizing gas and flow meter 46 is preferably a Coriolis or ultrasonic flow meter. In this way the flow of slurry is maintained constant through the interaction of the pressure regulator 26 and the mass flow meter 46, monitored by the controller 42. A Coriolis type flow meter is useful as it does not have any moving parts that could be worn by the solid particles in the suspension. It measures low flow rates for any density of the liquid and the uninterrupted flow passage though the metering device reduces the possibility of solids building up and causing obstructions.

Axial injection torch 12 is preferably an Axial III™ plasma torch produced by Northwest Mettech Corp., of North Vancouver, Canada with a modified injector tube as described below. Axial injection provides that the slurry is fed by particle feed conduit 22 through convergence blank 90 into the center of three converging plasma jets 48, is atomized and then all the particles are fully entrained in the plasma flame in convergence area 47 before exiting from nozzle 50. The Axial III™ torch 12 injects the atomized slurry feedstock axially in the direction of spray into the central core of the plasma overcoming the difficulties that arise when attempting to penetrate the plasma radially with fine particles or droplets.

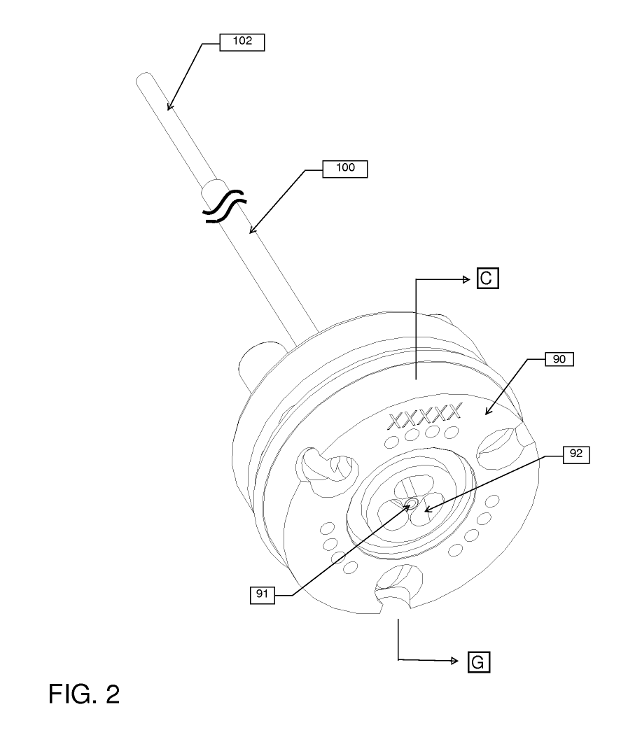

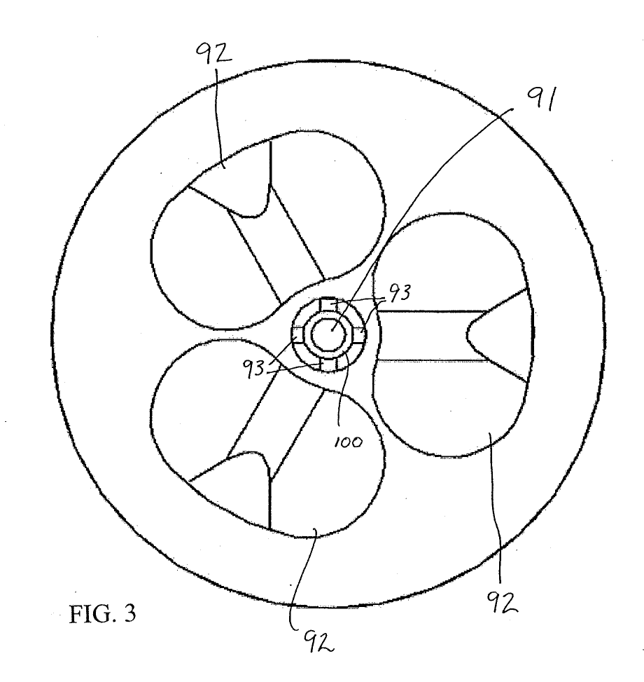

FIG. 2 illustrates the convergence blank 90 of axial injection torch 12. Convergence blank 90 has three converging channels 92 for the plasma sources, and central axial passage 91 for the liquid feed tube 100. The convergence area is shown in greater detail in FIG. 3. Centering tabs 93 are provided on tube 100 to center it in the convergence blank. The liquid feedstock in the axial injection torch is injected axially in the center of the three plasma channels 92. The size of the injector is limited to the dimensions between the plasma channels. The manner of injection of the slurry is critical in preventing clogging. Clogging at the injector needs to be avoided in spraying liquid feedstocks to produce thermal spray coatings. The present invention is aimed at minimizing clogging at the injector while reducing the pressure required in the injection lines.

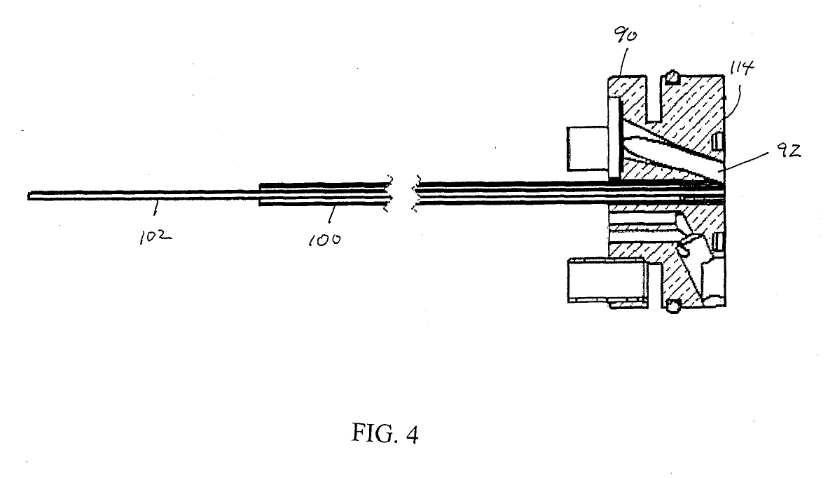

FIG. 4 illustrates a two fluid injector in convergence blank 90. The injector is a tube-in-tube injector with tube 102 for liquid on the inside and tube 100 for gas on the outside. Tube 100 is centered in blank 90 by centering tabs 93 as shown in FIG. 3. The ends of tube 100 and liquid tube 102 are flush with front 114 of the convergence blank 90.

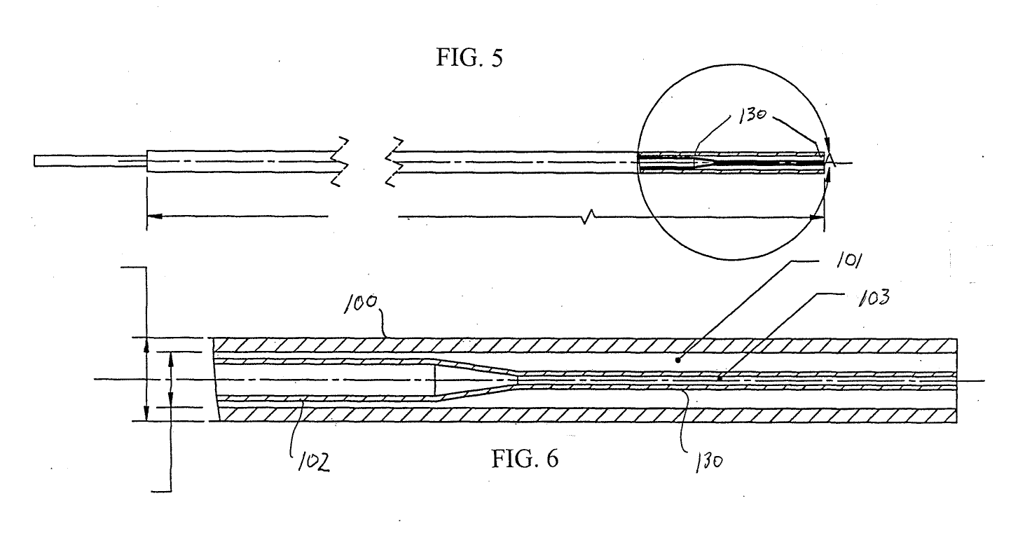

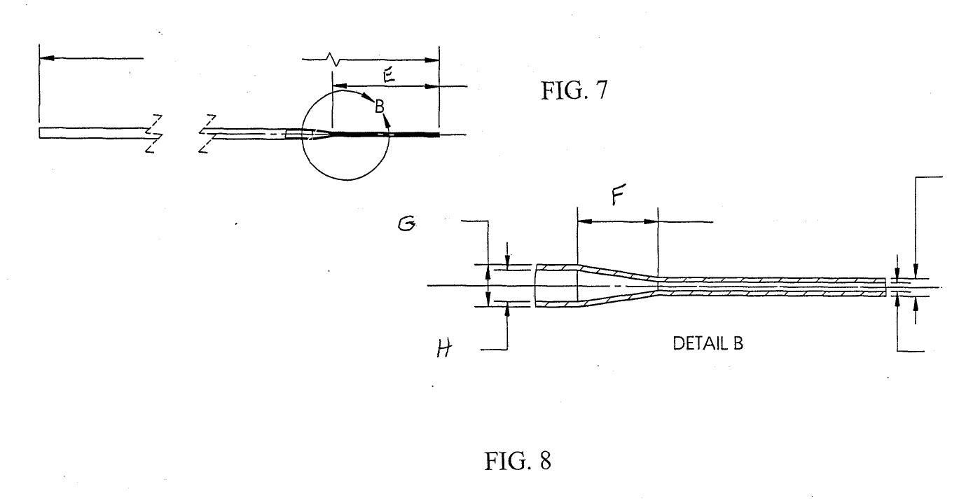

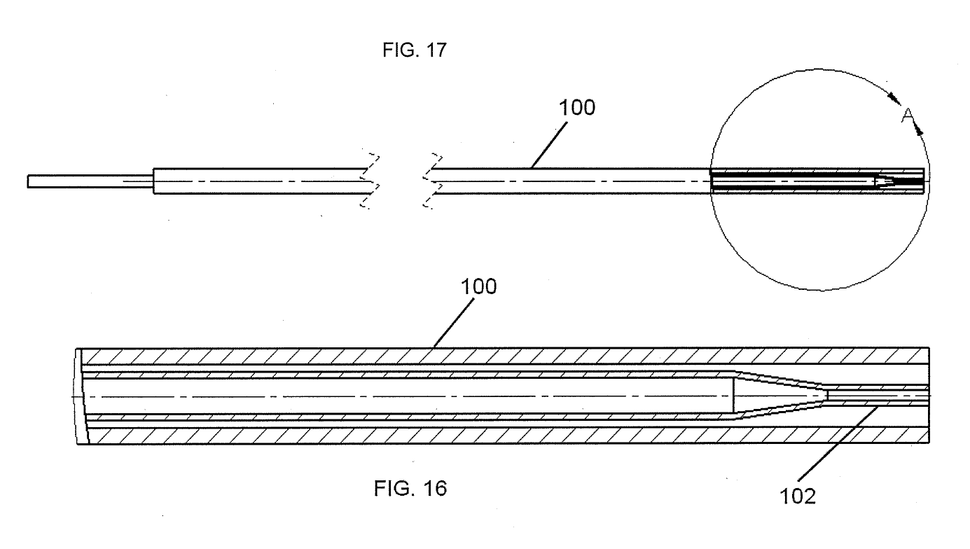

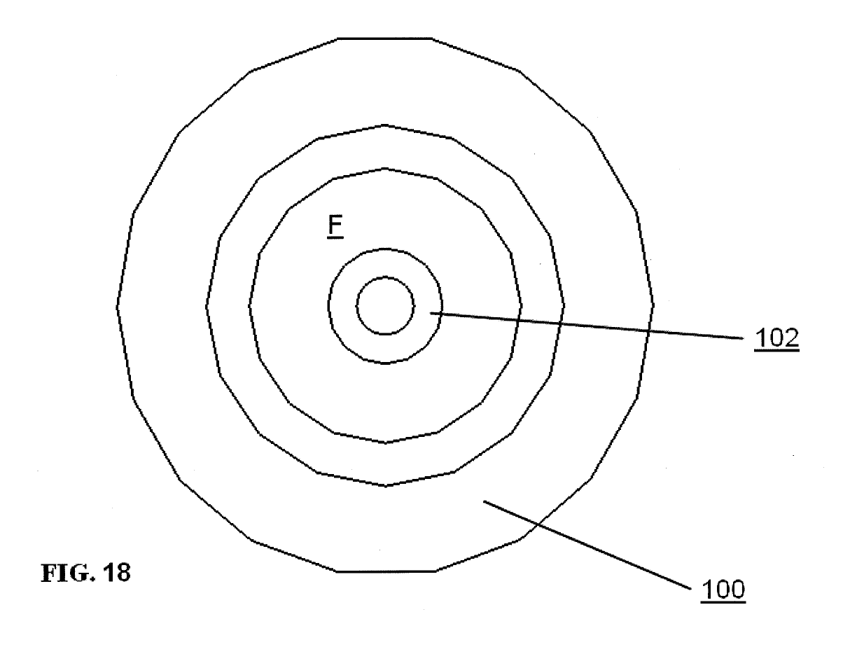

A first embodiment of the improved form of liquid injector is shown in FIG. 5-8. Inner tube 102 and outer tube 100 form passage 101 for atomizing gas and passage 103 for liquid. The end 130 of inner tube 102 is swaged to a reduced diameter over a length E of as long as 4 inches of a total length of tube 102 which is 6 inches to 30 inches. Preferably length E is less than about 1 inch. The length of tapered section F may be from 1/16 inches to 3 inches and preferably about 3/16 inches. Most preferably as shown in FIG. 16-18, a length of 0.2 inches for the length E of the swaged section 130 has been found to effectively allow for pressure reduction in the feed line without affecting torch parameters, and clogging of this short part can be cleaned up easily by the operator from the exterior of the torch without the need for disassembling the torch. In that case length F is about 0.188 inches.

The outer diameter G of tube 102 is reduced from 0.095 inches in the unswaged area to 0.04 inches in the swaged area, and the inner diameter H from 0.071 inches in the unswaged area to 0.02 inches in the swaged area.

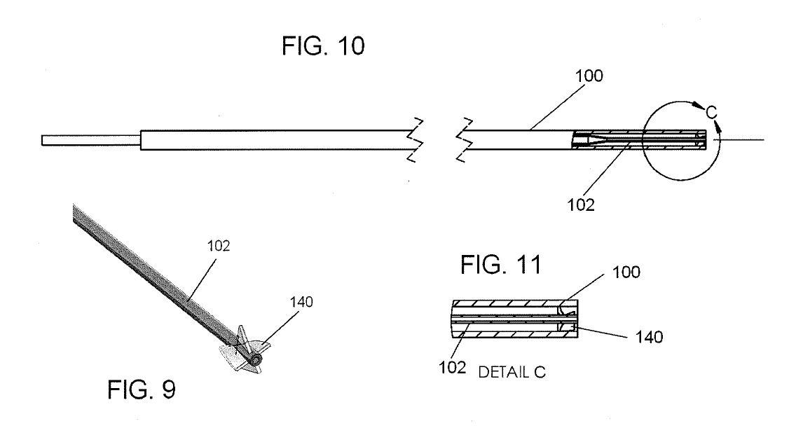

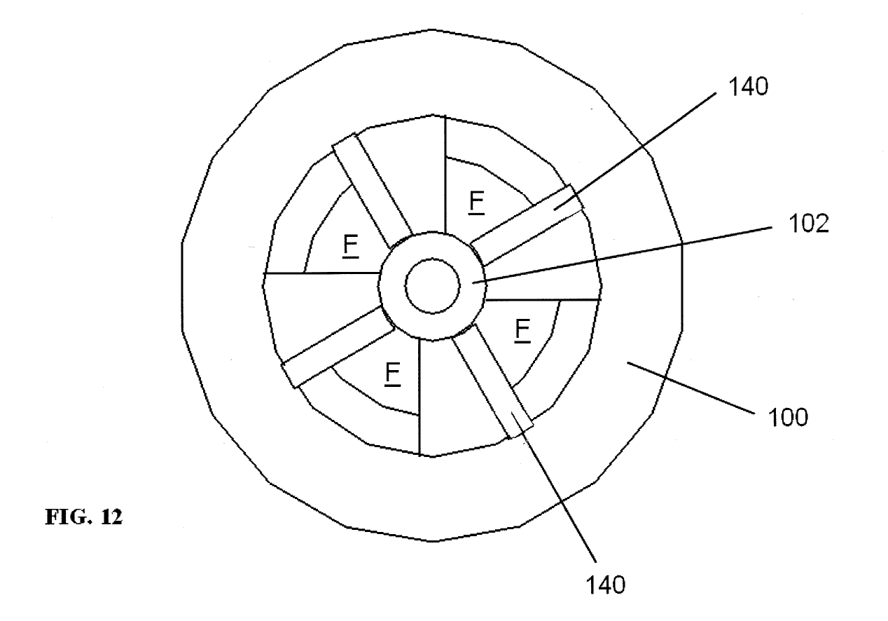

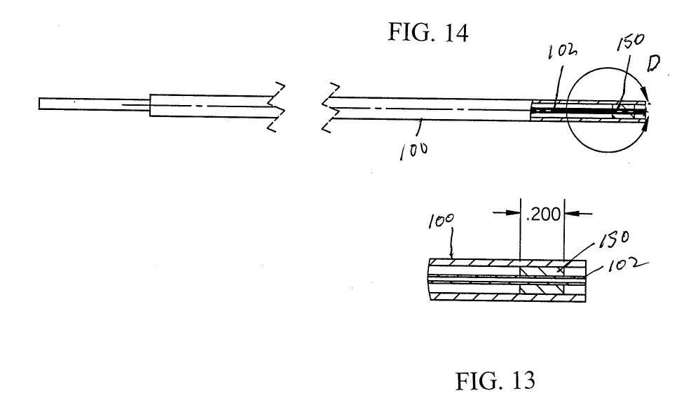

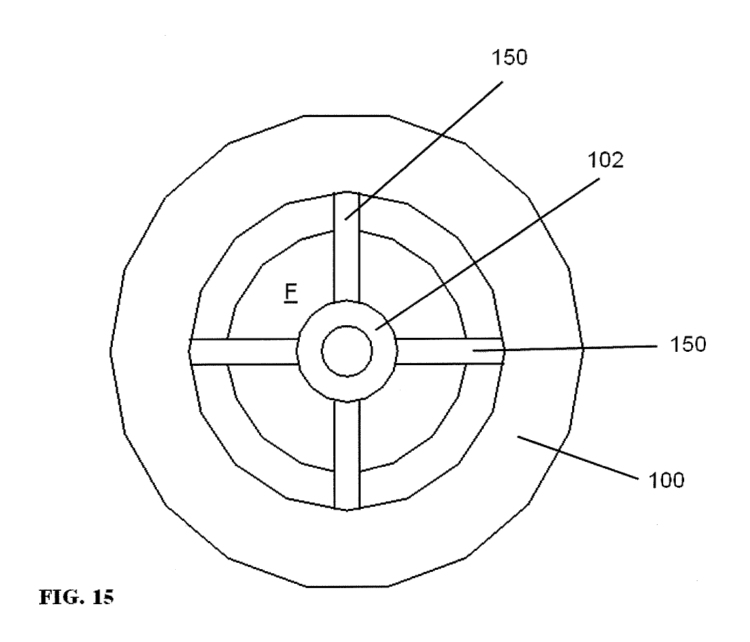

As a further improvement, vanes 140 can be placed on the outer surface of inner tube 102 adjacent the end of the injector tube 102. A first version is shown in FIG. 9-12 in which four twisted vanes 140 are provided to provide a swirl to the gas flow in tube 100. The second version in FIG. 13-15 has vanes 150 which are straight and parallel to the longitudinal axis of tube 102, which act as spacers to maintain the concentricity of inner tube 102 in tube 100. Each vane 150 has a length preferably about 0.2 inches and width about 0.01 inches. Such straight vanes also serve to straighten and thereby accelerate and focus the flow of gas at the exit of the injector tube in cases where the incoming gas flow is non-linear, and may be turbulent.

By reducing the diameter of the end of tube 102 by swaging a reduced pressure in the feed line can be used. This has the advantage of saving energy costs. Also lower pressure results in a longer lifetime for the peristaltic pump tubing, which reduces maintenance costs. Thirdly, less volume of pressure dampener is required in the feedstock to provide the necessary smoothing of pressure pulses for the peristaltic pump. As a result less of the costly liquid is lost when residual pressure forces it out of the feed line when the pump is stopped. Fourthly, operating at a lower pressure opens up the possibility of using a greater variety of pumps or using the pressurized tank. Also by providing the swirl in the atomizing gas the clogging in the end of the injector is reduced. By extending the ends of tube 100 and liquid tube 102 to be flush with front 114 of the convergence blank 90, cleaning of the end of tubes 100, 102 is facilitated without disassembling the torch.

### Example

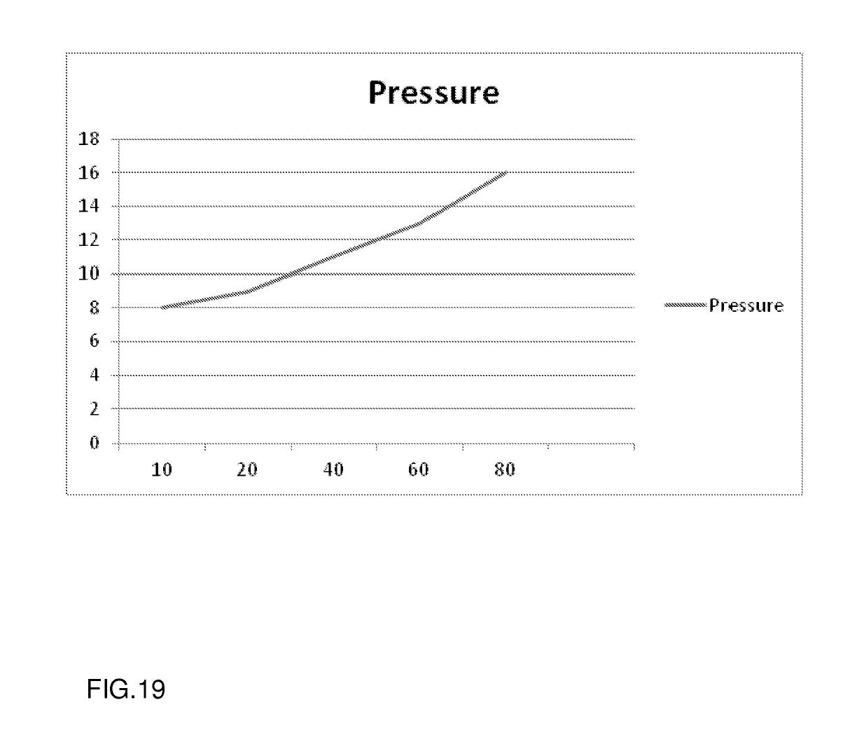

A test set-up was made to compare the pressure required for the improved injector compared to prior injectors. A 1/16″ tube in tube, with the liquid on the inner tube was used. The slurry feeder used a 1/16″ feed line. The liquid feed rate was 1.2 kg/hr. The liquid precursor was 20% ceramic powder and 80% ethanol. As shown in the table of FIG. 19, it was found that pressure in the injection line which was previously 50 psi at a flow rate of 20 ml/min dropped to 10 psi at a flow rate of 20 ml/min. No clogging was detected. The injector port could be cleaned from the open side without disassembling the torch.

The present invention therefore minimizes clogging at the injector while reducing the pressure required in the liquid feedstock feed lines. It does this by providing a liquid-in-gas injector tube in which the diameter of the inner liquid-bearing tube within the gas-transmitting tube is reduced adjacent the outlet end of the injector. Clogging may be further reduced by adding vanes to the outer surface of the inner liquid-bearing tube within the gas-transmitting tube to impart swirling or otherwise focus the flow of gas at the exit of the injector tube.

While a number of exemplary aspects and embodiments have been discussed above, those of skill in the art will recognize certain modifications, permutations, additions and sub-combinations thereof. It is therefore intended that the invention be interpreted to include all such modifications, permutations, additions and sub-combinations as are within its true spirit and scope.

What is claimed is:

1. A liquid-in-gas injector tube for use in injecting liquid feedstock in an axially injected plasma torch, said injector tube having an outlet end and comprising an inner liquid-bearing tube concentrically arranged within a gas-transmitting tube, wherein the diameter of the inner liquid-bearing tube is reduced adjacent the outlet end of the injector tube.

2. The liquid-in-gas injector tube of claim 1 wherein the diameter of the inner liquid-bearing tube within the gas-transmitting tube is reduced adjacent the outlet end of the injector by swaging.

3. The liquid-in-gas injector tube of claim 2 wherein the swaged end of the inner tube has a tapered section and a cylindrical section of reduced diameter.

4. The liquid-in-gas injector tube of claim 3 wherein the tapered section has a length between 1/16 inches and 3 inches and the cylindrical section has a length less than 4 inches.

5. The liquid-in-gas injector tube of claim 4 wherein the tapered section has a length of about 3/16 inches.

6. The liquid-in-gas injector tube of claim 4 wherein the cylindrical section has a length of less than 1 inch.

7. The liquid-in-gas injector tube of claim 6 wherein the tapered section has a length of about 0.188 inches and the cylindrical section has a length of about 0.2 inches.

8. The liquid-in-gas injector tube of claim 1 wherein the inner diameter of the inner liquid-bearing tube is about 0.02 inches.

9. The liquid-in-gas injector tube of claim 2 wherein the inner diameter of the inner liquid-bearing tube is about 0.02 inches.

10. The injector tube of claim 1 wherein a plurality of twisting vanes is provided on the outer surface of the inner liquid-bearing tube adjacent the outlet end thereof within the gas-transmitting tube to impart swirling of gas at the outlet end of the injector tube.

11. The injector tube of claim 1 wherein a plurality of vanes extending parallel to the longitudinal axis of the tube is provided on the outer surface of the inner liquid-bearing tube adjacent the outlet end thereof within the gas-transmitting tube to straighten the flow of gas at the exit of the injector tube.

12. The injector tube of claim 1 wherein said axial injection torch comprises a convergence blank and the outlet end of the injector tube is flush with front of the convergence blank.

13. A thermal spray system comprising:
i) an axial injection torch comprising the injector tube of claim 1;
ii) a liquid feedstock delivery unit providing liquid feedstock to a feed line communicating with said axial torch;
iii) a source of pressure for delivering the liquid feedstock;
iv) a source of atomizing gas;
wherein the pressure in said feed line is maintained at a reduced level.

14. The thermal spray system of claim 13 wherein the pressure in said feed line is maintained at 10 psi or less at a flow rate of 20 ml/min.

15. The thermal spray system of claim 13 comprising the injector tube of claim 2.

16. The thermal spray system of claim 13 comprising the injector tube of claim 7.

17. A method of spraying coatings from a liquid feedstock using a thermal spray system to reduce clogging of the feedstock, wherein the thermal spray system comprises i) an axial injection torch comprising the injector tube of claim 1; ii) a liquid feedstock delivery unit providing liquid feedstock to a feed line communicating with said axial torch; iii) a source of pressure for delivering the liquid feedstock; iv) a source of atomizing gas; said method comprising:
a) delivering said liquid feedstock to said axial injection torch while maintaining the pressure in said feed line at a reduced level;
b) axially injecting said liquid feedstock into the plasma steam generated by said axial injection torch through said injector tube whereby the rate of flow of said liquid feeds diameter of the inner liquid-bearing tube is increased adjacent the outlet end of the injector tube by the reduced diameter of the inner liquid-bearing tube is reduced adjacent the outlet end of the injector tube; and
c) controlling the flow of gas within the gas-transmitting tube at the outlet end of the injector tube by providing a plurality of vanes on the outer surface of the inner liquid-bearing tube within the gas-transmitting tube.

18. The method of claim 17 wherein the flow of gas within the gas-transmitting tube at the outlet end of the injector tube is controlled by providing a plurality of twisting vanes on the outer surface of the inner liquid-bearing tube adjacent the outlet end thereof within the gas-transmitting tube to impart swirling of gas at the outlet end of the injector tube.

19. The method of claim 17 wherein the flow of gas within the gas-transmitting tube at the outlet end of the injector tube is controlled by providing a plurality of vanes extending parallel to the longitudinal axis of the tube on the outer surface of the inner liquid-bearing tube adjacent the outlet end thereof within the gas-transmitting tube to straighten the flow of gas at the exit of the injector tube.
